(19) United States
(12) Patent Application Publication
(10) Pub. No.: US 2007/0047406 A1
(43) Pub. Date: Mar. 1, 2007

(54) Optical disk apparatus

(75) Inventors: Tomonori Yamashita, Kawasaki (JP); Toru Ikeda, Kawasaki (JP)

Correspondence Address: Patrick G. Burns;GREER, BURNS & CRAIN, LTD., Suite 2500, 300 South Wacker Drive, Chicago, IL, 60606, US

(73) Assignee: FUJITSU LIMITED

(21) Appl. No.: 11/512,734

(22) Filed: Aug. 30, 2006

(30) Foreign Application Priority Data
Aug. 31, 2005 (JP) 2005-252661

(51) Int. Cl. G11B 19/00

(52) U.S. Cl. 369/47.38

(57) ABSTRACT

An optical disk apparatus includes a carriage actuator that drives the carriage with a two-phase stepping motor. The carriage is provided with an objective lens that condenses a laser beam onto an optical disk and a lens actuator that moves the objective lens. A system controller drives the two-phase stepping motor in a first conduction mode of supplying current only to A-phase exciting coil and a second conduction mode of supplying current only to B-phase exciting coil in one-phase excitation drive mode, and detects a travel distance of the carriage based on a relative displacement of the objective lens with respect to the carriage, thus to control the current conduction to the A-phase exciting coil and the B-phase exciting coil based on the detection result, such that the travel distance of the carriage in the first and the second conduction mode becomes substantially the same.

### BACKGROUND OF THE INVENTION

1. Field of the Invention

The present invention relates to an optical disk apparatus for a MO or the like, which includes a stepping motor for driving an optical head, and more particularly to a technique of stabilizing the torque that drives the optical head.

2. Description of the Related Art

An optical disk apparatus includes a semiconductor laser that generates a laser beam, and irradiates a surface of a disk with the laser beam converged into a fine beam spot through an objective lens, to thereby write or read information in or out of the disk surface. When using a magneto-optical disk for example, the disk surface includes a guide groove formed in a spiral for guiding the beam spot, so that the information is recorded on a rib-shaped portion (land) between the grooves. The land corresponds to a track on which the information is recorded, and a round course of the track is divided into a plurality of sectors (recording unit of information).

Accordingly, when controlling the access by the beam spot to the disk surface for recording and reproducing the information in and out of the track, the beam spot is relatively moved along the groove by rotating the disk, so that the beam spot reaches the designated track to read out address information of the sectors on the track, thus to be positioned at the recording position or the reproducing position (sector position) of the designated information.

For performing as quickly as possible such action of moving the beam spot radially of the disk thus to set the beam spot at the target track out of the plurality of tracks provided in the disk (hereinafter, “seek action”), the optical disk apparatus includes an optical head with an optical element that generates the beam spot (including a semiconductor laser, an objective lens, a tracking signal detection system, a focus signal detection system) installed so as to move radially of the disk, and with an optical element such as an objective lens that controls the direction of the optical axis of the beam spot, mounted on the optical head to be independently controlled radially of the disk in a fine increment of displacement. Thus, the optical disk apparatus performs an integrated seek control including moving the entirety of the optical head radially of the disk over a large distance to bring the optical head close to the target track (rough seek action), and displacing only the beam spot with the objective lens radially of the disk in a fine increment thus to accurately set the beam spot at the target track (precise seek action).

The optical head employed for such seek control is provided with an actuator including a stepping motor as the driving source, because of excellent positioning control performance and compatibility with a digital control system, for moving the entire optical head radially of the disk (hereinafter, “carriage actuator”), and an actuator that utilizes a magnetic force to micro-adjust the position of the objective lens so as to independently move the beam spot radially of the disk (hereinafter, “lens actuator”).

The carriage actuator works in two driving modes, including moving the carriage at a high speed from a current track position toward a target track position relatively distant in a radial direction, and moving the carriage at a low speed to facilitate the beam spot to follow up the track according to the rotation of the disk, and hence the torque of the stepping motor employed in the carriage actuator is to vary over a relatively extensive range. Related patent documents are JP-A-H10-290598, JP-A-2000-339729, and JP-A-2003-281746, for example.

As is known, the stepping motor includes at least two systems of exciting coils, and switches the current conduction to each of the exciting coils at every driving pulse so as to rotate a rotor in a unit of a step angle. Accordingly, if the torque is generated in different values with each driving pulse, torque fluctuation is incurred, which leads to fluctuation in rotation speed as well as in rotational position.

When moving the carriage with a relatively large torque (in the high speed motion), influence of the torque fluctuation to the moving speed or moving position of the carriage may be negligible. When moving the carriage with a relatively small torque (in the low speed motion), however, the influence of the torque fluctuation to the moving speed or moving position of the carriage has to be addressed.

In the optical disk apparatus, the travel distance of the carriage per driving pulse of the stepping motor is 50 μm approximately in general, which is larger than the track pitch. Accordingly, if the torque generated at each driving pulse fluctuates in the low torque driving mode of the stepping motor, the moving speed and the moving position of the carriage largely fluctuates, which imposes an undesirable impact on the displacement control performed by the lens actuator for allowing the beam spot to follow up the groove of the disk.

Hereunder, the torque fluctuation of the stepping motor and the impact thereof will be specifically described, taking up a hybrid type (HB) two-phase stepping motor as an example.

FIGS. 9A to 9C are diagrams showing a rotation mechanism of an HB type two-phase stepping motor.

The stepping motor shown in FIGS. 9A to 9C includes two cylindrical rotors 201, 202, respectively made of a permanent magnet and having fifteen teeth 201a, 202a around the circumference thereof, attached to a shaft with an angular shift corresponding to half a pitch of the teeth between the rotor 201 and the rotor 202. The rotor 201 is magnetized as N pole and the rotor 202 as S pole, so that the teeth 201a of the rotor 201 constitute N magnetic poles, while the teeth 202a of the rotor 202 constitute S magnetic poles. Accordingly, when viewed in an axial direction of the rotors 201, 202, totally 30 pieces of N magnetic pole 201a and S magnetic pole 202a are alternately aligned circumferentially, in a pitch of 12 degrees from a reference position R on the N magnetic pole 201a marked with a black circle. Here, FIGS. 9A to 9C show a step angle θs in a larger angle than it actually is, for the sake of explicitness of the drawings.

Around the rotors 201, 202, four magnetic poles respectively made of an electromagnet are located above and below, and at the right and the left of a stator, so as to constitute an A-phase magnetic pole including the pair of upper and lower magnetic poles 203, 204, and a B-phase magnetic pole including the pair of right and left magnetic poles 205, 206. Each of the magnetic poles 203 to 206 is provided with grooves on its tip portion, which forms a plurality of teeth 203a to teeth 206a. An exciting coil is wound on the magnetic poles 203, 204 for use in common (hereinafter, “A-phase exciting coil”), so that when a current is supplied to the exciting coil the teeth 203a of the magnetic pole 203 and the teeth 204a of the magnetic pole 204 generate different magnetic poles from each other (Ref. FIG. 9A). Specifically, when the magnetic pole 203a becomes the S pole, the magnetic pole 204a becomes the N pole, while when the magnetic pole 203a becomes the N pole the magnetic pole 204a becomes the S pole.

Likewise, an exciting coil is wound on the magnetic poles 205, 206 for use in common (hereinafter, “B-phase exciting coil”), so that when a current is supplied to the exciting coil the teeth 205a of the magnetic pole 205 and the teeth 206a of the magnetic pole 206 generate different magnetic poles from each other (Ref. FIG. 9B). Specifically, when the magnetic pole 205a becomes the S pole, the magnetic pole 206a becomes the N pole, while when the magnetic pole 205a becomes the N pole the magnetic pole 206a becomes the S pole.

When a current is supplied to the A-phase exciting coil so as to form the S pole on the magnetic pole 203a and to form the N pole on the magnetic pole 204a (hereinafter, “A-phase forward excitation”), and the exciting coil on the magnetic poles 205a, 206a is disconnected, the magnetic pole 201a stops at a position opposing the magnetic pole 203a, as shown in FIG. 9A. Upon supplying a current, under such state, to the B-phase exciting coil so as to form the N pole on the magnetic pole 205a and to form the S pole on the magnetic pole 206a (hereinafter, “B-phase forward excitation”), and the exciting coil on the magnetic poles 203a, 204a is disconnected, the magnetic pole 202a rotates to a position opposing the magnetic pole 205a, as shown in FIG. 9B. In other words, the magnetic pole 202a rotates by a step angle θs (12 degrees in this embodiment) from the reference position R.

Now, when a current is supplied to the A-phase exciting coil so as to form the N pole on the magnetic pole 203a and to form the S pole on the magnetic pole 204a (hereinafter, “A-phase reverse excitation”), and the exciting coil on the magnetic poles 205a, 206a is disconnected, the magnetic pole 201a rotates to a position opposing the magnetic pole 204a, as shown in FIG. 9C, and upon further supplying a current to the B-phase exciting coil so as to form the S pole on the magnetic pole 205a and to form the N pole on the magnetic pole 206a (hereinafter, “B-phase reverse excitation”), and the exciting coil on the magnetic poles 203a, 204a is disconnected, the magnetic pole 202a rotates to a position opposing the magnetic pole 206a, though not shown.

Sequentially switching the current conduction as above to the A-phase exciting coil and the B-phase exciting coil subsequently can cause the rotor to rotate in increments of the step angle θs.

FIG. 10 is a chart showing a relation between a conduction pattern to the A-phase exciting coil and the B-phase exciting coil and a torque and rotation speed of the rotor, in the one-phase excitation drive mode.

In FIG. 10, the codes “A”, “B”, “XA”, “XB” respectively represent “A-phase forward excitation”, “B-phase forward excitation”, “A-phase reverse excitation”, and “B-phase reverse excitation”. The one-phase excitation drive mode repeats the “A-phase forward excitation”, “B-phase forward excitation”, “A-phase reverse excitation”, and “B-phase reverse excitation” in a predetermined period T, to thus rotate the rotor. The numerals (1) to (4) at the top of FIG. 10 respectively correspond to the excitation modes of the “A-phase forward excitation”, “B-phase forward excitation”, “A-phase reverse excitation”, and “B-phase reverse excitation”.

FIG. 10 shows a case where the A-phase exciting coil and the B-phase exciting coil have different excitation characteristics, such that although a same driving voltage is applied to the A-phase exciting coil and the B-phase exciting coil, a magnetic field generated around the magnetic poles 203a, 204a and a magnetic field generated around the magnetic poles 205a, 206a become unbalanced, thereby making the attractive force (torque) of the magnetic poles 203a, 204a with respect to the magnetic pole 201a of the rotor 201 smaller than the attractive force (torque) of the magnetic pole 205a, 206a with respect to the magnetic pole 202a of the rotor 202.

Reasons that the excitation characteristics of the A-phase exciting coil and the B-phase become different are, as mentioned in JP-A-H10-290598 and JP-A-2003-281746, that the A-phase exciting coil and the B-phase exciting coil have different resistance values which makes the current value different between the exciting coils, or that the running mode of the current is different though the current values of the exciting coils is equal, which results in generation of different magnetic fields, or that the exciting coils have different temperature characteristics, which leads to different excitation characteristic depending on the temperature condition.

In the one-phase excitation drive mode, the magnetic pole 201a of the rotor 201 stops at the position opposing the magnetic poles 203a, 204a of the stator, and the magnetic pole 202a of the rotor 202 stops at the position opposing the magnetic pole 205a, 206a of the stator, in the respective excitation modes (1) to (4). Repeating thus the excitation mode (1) to (4) sequentially cause the movement of the magnetic pole 201a to the position opposing the magnetic pole 203a of the stator, the movement of the magnetic pole 202a to the position opposing the magnetic pole 205a, movement of the magnetic pole 201a to the position opposing the magnetic pole 204a and the movement of the magnetic pole 202a to the position opposing the magnetic pole 206a in repeated cycles thus rotating the rotor, in the one-phase excitation drive mode.

FIG. 11 is a schematic diagram showing a relation between a direction of the exciting current and a rotational position of the rotor, in the one-phase excitation drive mode.

In the one-phase excitation drive mode, which includes four excitation modes (1) to (4), the “A-phase forward excitation”, “B-phase forward excitation”, “A-phase reverse excitation”, and “B-phase reverse excitation” are independently performed as is apparent from the excitation pattern shown in FIG. 10. Accordingly, in FIG. 11, the excitation modes (1) to (4) are respectively allocated to four directions of “A”, “B”, “XA”, “XB” which are orthogonal to one another, so as to indicate the magnitude of the exciting current in each excitation mode (1) to (4) by arrows. In this example, it is assumed that the magnitude of the torque is proportional to that of the exciting current.

If the exciting currents in the excitation modes (1) to (4) are of the same magnitude, the arrows in the respective directions “A”, “B”, “XA”, “XB” have the same length and hence the points of the arrows fall on a circumference of the same circle. In the example of FIG. 10, however, since the exciting current of the excitation modes(1), (3) is smaller than that of the excitation modes (2), (4), the points of the arrows in the directions “A”, “B”, “XA”, “XB” fall on a circumference of a horizontally oriented ellipse.

Since the exciting currents in the directions “A”, “B”, “XA”, “XB” are not simultaneously supplied, and hence the reference position R of the rotor moves stepwise in the directions “A”, “B”, “XA”, “XB” each time the excitation mode is switched from (1) toward (4). Accordingly, in FIG. 11, the interval between adjacent directions, for instance between the directions “A” and “B”, corresponds to the step angle θs.

In the one-phase excitation drive mode, when the A-phase exciting coil and the B-phase exciting coil have different excitation characteristics, though the rotational positions of the rotor upon each advance by the step angle θs do not fluctuate, the rotational speed fluctuates, as the speed fluctuation represented by the waveform shown in FIG. 10, which may generate vibration when moving the carriage. It is now apparent that the speed fluctuation becomes larger as the horizontally oriented ellipse in FIG. 11 becomes further flattened.

FIG. 12 is a chart showing a relation between a conduction pattern to the A-phase exciting coil and the B-phase exciting coil and a torque and rotation speed of the rotor, in the two-phase excitation drive mode. FIG. 13 is a schematic diagram showing a relation between a direction of the exciting current and a rotational position of the reference position R of the rotor, in the two-phase excitation drive mode.

As shown in FIG. 12, the two-phase excitation drive mode performs two excitation modes at a time out of the “A-phase forward excitation”, “B-phase forward excitation”, “A-phase reverse excitation”, and “B-phase reverse excitation”. Since the combination of the modes can be made in four sets, basically four excitation modes are performed, similarly to the one-phase excitation drive mode.

A difference of the two-phase excitation drive mode from the one-phase excitation drive mode is that the exciting current is constantly supplied to both of the A-phase exciting coil and the B-phase exciting coil throughout the excitation modes (1) to (4) in the two-phase excitation drive mode, by which the rotational position of the rotor in the excitation modes (1) to (4) fall on a middle point between the directions “A”, “B”, “XA”, “XB” as shown in FIG. 13, and that a greater torque is generated than in the one-phase excitation drive mode.

If the A-phase exciting coil and the B-phase exciting coil have the same excitation characteristic, the direction of the exciting current in the excitation modes (1) to (4) (direction composed of the exciting current to the A-phase exciting coil and the exciting current to the B-phase exciting coil regarded as vectors) becomes ±45 degrees and ±135 degrees with reference to the direction “A” (which correspond to the rotational positions in the excitation modes (1) to (4)) as indicated by dash-dot lines in FIG. 13, and the magnitude of the exciting current in the respective direction also becomes equal. When the A-phase exciting coil and the B-phase exciting coil have different excitation characteristics, however, the direction of the exciting current, i.e. the rotational positions in the excitation modes (1) to (4) are shifted from the directions of ±45 degrees and ±135 degrees, as indicated by solid lines in FIG. 13.

The amount of such shift in direction becomes larger as the difference in excitation characteristic between the A-phase exciting coil and the B-phase exciting coil becomes greater, such that, in the example of FIG. 13, the directions in the excitation modes (1), (2) move closer to the direction “B” and the directions in the excitation modes (3), (4) move closer to the direction “XB” as the exciting current to the B-phase exciting coil becomes larger by a greater difference than the exciting current to the A-phase exciting coil.

FIG. 14 is a line graph showing a shift in rotational positions in each excitation mode caused by imbalance in torque, in the two-phase excitation drive mode.

If the A-phase exciting coil and the B-phase exciting coil have the same excitation characteristic, the rotational positions in the excitation modes (1) to (4) become shifted by 45 degrees from those in the one-phase excitation drive mode, while the step angle θs remains unchanged in all the excitation modes (1) to (4). Accordingly, as indicated by dash-dot lines in FIG. 14, rotational positions P1′, P2′, P3′, P4′ in the excitation modes (1) to (4) fall on positions evenly spaced by the step angle θs, which means that the rotor rotates at uniform intervals with each driving pulse.

In contrast, if the A-phase exciting coil and the B-phase exciting coil have different excitation characteristics and hence the rotational positions at the excitation modes (1) to (4) are shifted as indicated by the solid lines in FIG. 13, the step angle θs″ in the excitation modes (1), (3) becomes greater than the step angle θs′ in the excitation modes (2), (4) as indicated by solid lines in FIG. 14, which causes the rotor to rotate in a wide and a narrow strokes alternately with each driving pulse. Thus in the two-phase excitation drive mode, fluctuation both in rotation speed and rotational position is incurred, which not only provokes vibration but also affects the displacement control of the objective lens, when moving the carriage. This leads to such a problem that, despite setting a certain fixed amount for compensation of the displacement control of the objective lens based on the movement of the carriage, such compensation in the displacement control of the objective lens may result in being ineffective because of the fluctuation in moving position of the carriage with each driving pulse.

FIG. 15 is a chart showing a relation between a conduction pattern to the A-phase exciting coil and the B-phase exciting coil and a torque and rotation speed of the rotor, in the one-two-phase excitation drive mode. FIG. 16 is a schematic diagram showing a relation between a direction of the exciting current and a rotational position of the reference position of the rotor, in the one-two-phase excitation drive mode.

As shown in FIG. 15, the one-two-phase excitation drive mode is a combination of the one-phase excitation drive mode and the two-phase excitation drive mode. Accordingly, the one-two-phase excitation drive mode has a double number of basic excitation modes of that of the one-phase excitation drive mode or the two-phase excitation drive mode, i.e. eight modes. The relation between the exciting current direction and the rotational position of the reference position R of the rotor in the one-two-phase excitation drive mode is, accordingly, a composition of the diagram of FIG. 11 showing the one-phase excitation drive mode and the diagram of FIG. 13 showing the two-phase excitation drive mode, as shown in FIG. 16.

In FIG. 15, the excitation modes (1), (3), (5), (7) of the one-two-phase excitation drive mode respectively correspond to the excitation modes(1) to (4) of the one-phase excitation drive mode shown in FIG. 9, while the excitation modes (2), (4), (6), (8) of the one-two-phase excitation drive mode respectively correspond to the excitation mode (1) to (4) of the two-phase excitation drive mode shown in FIG. 12. Likewise in FIG. 16, the positions in the excitation modes (1), (3), (5), (7) of the one-two-phase excitation drive mode respectively correspond to the positions in the excitation modes(1) to (4) of the one-phase excitation drive mode shown in FIG. 11, while the positions in the excitation modes (2), (4), (6), (8) of the one-two-phase excitation drive mode respectively correspond to the positions in the excitation mode (1) to (4) of the two-phase excitation drive mode shown in FIG. 13.

Since the one-two-phase excitation drive mode is the combination of the one-phase excitation drive mode and the two-phase excitation drive mode, when the A-phase exciting coil and the B-phase exciting coil have different excitation characteristics, the foregoing problems incidental to the one-phase excitation drive mode and to the two-phase excitation drive mode are superposed, which further affects the stability in the movement control of the carriage of the optical disk apparatus.

### SUMMARY OF THE INVENTION

The present invention has been conceived in view of the foregoing problems, with an object to provide an optical disk apparatus capable of learning a conduction pattern to an A-phase exciting coil and a B-phase exciting coil so as to substantially level off a magnitude of a torque in each excitation mode according to an excitation mode, thereby suppressing fluctuation in moving speed and displacement position of a carriage with each driving pulse.

According to the present invention, there is provided an optical disk apparatus provided with an optical head including a carriage disposed so as to oppose an optical disk and to move radially of the optical disk, a driver including a multi-phase stepping motor as a driving source that drives the carriage, an objective lens mounted on the carriage so as to be displaced radially of the optical disk for condensing a laser beam on the optical disk, and a shifter that displaces the objective lens, comprising: a drive controller that drives the multi-phase stepping motor according to at least two conduction modes different from each other with respect to a first, a second, . . . , and an nth exciting coils of the multi-phase stepping motor; a detector that detects a moving speed or a travel distance of the carriage in each of the conduction modes when the drive controller causes the multi-phase stepping motor to move the carriage; and a conduction adjuster that adjusts a current amount to be supplied to the first, the second, . . . , and the nth exciting coils, according to a detection result by the detector, such that the moving speed or the travel distance of the carriage in the at least two conduction modes becomes substantially the same.

Preferably, the multi-phase stepping motor is a two-phase stepping motor, to be driven according to the conduction modes with respect to the first exciting coil and the second exciting coil.

Preferably, the conduction modes include a first conduction mode of supplying a current only to the first exciting coil and a second conduction mode of supplying a current only to the second exciting coil in a one-phase excitation drive; and the conduction adjuster adjusts a current amount to be supplied to the first exciting coil and the second exciting coil, such that the moving speed or the travel distance of the carriage in the first and the second conduction modes becomes substantially the same.

Preferably, the conduction modes include a third conduction mode of supplying a current to both the first and the second exciting coil in the two-phase excitation drive, and a fourth conduction mode of supplying a current in a different direction from that in the third conduction mode, with respect to one of the first and the second exciting coils; and the conduction adjuster adjusts a current amount to be supplied to the first exciting coil and the second exciting coil, such that the moving speed or the travel distance of the carriage in the third and the fourth conduction modes becomes substantially the same.

Preferably, the conduction modes include a fifth conduction mode of supplying a current only to the first exciting coil, a sixth conduction mode of supplying a current only to the second exciting coil, and a seventh conduction mode of supplying a current to both the first and the second exciting coil, in a one-two-phase excitation drive; and the conduction adjuster adjusts a current amount to be supplied to the first exciting coil and the second exciting coil, such that the moving speed or the travel distance of the carriage in the fifth to the seventh conduction modes becomes substantially the same.

Preferably, the detector includes a displacement position detector that detects a displacement position of the objective lens on the carriage in each of the conduction modes, and a calculator that calculates a travel distance of the carriage based on a displacement position of the objective lens detected by the displacement position detector.

According to the present invention, the multi-phase stepping motor is driven according to at least two conduction modes different from each other with respect to the first, the second, . . . , and the nth exciting coil of the multi-phase stepping motor, and the moving speed or the travel distance of the carriage thereby driven is detected.

For example, when the multi-phase stepping motor is a two-phase stepping motor to be driven according to conduction modes with respect to the first exciting coil and the second exciting coil, in the case of the one-phase excitation drive mode, the two-phase stepping motor is driven in the first conduction mode of supplying a current only to the first exciting coil or a second conduction mode of supplying a current only to the second exciting coil, and the moving speed or the travel distance of the carriage thereby achieved is detected. On the other hand, in the case of the two-phase excitation drive mode, the two-phase stepping motor is driven in the third conduction mode of supplying a current to both the first and the second exciting coil, or the fourth conduction mode of supplying a current in a different direction from that in the third conduction mode, with respect to one of the first and the second exciting coil, and the moving speed or the travel distance of the carriage thereby achieved is detected. Further, in the case of the one-two-phase excitation drive mode, the two-phase stepping motor is driven in the fifth conduction mode of supplying a current only to the first exciting coil, the sixth conduction mode of supplying a current only to the second exciting coil, or the seventh conduction mode of supplying a current to both the first and the second exciting coil, and the moving speed or the travel distance of the carriage thereby achieved is detected.

Then based on the respective detection results, the amount of a current to be supplied to the first, the second, and the nth exciting coil is adjusted, such that the moving speed or the travel distance of the carriage in the respective conduction modes becomes substantially the same. Therefore, difference in torque among the conduction modes can be minimized in each excitation drive mode, even though the first and the second exciting coil have different excitation characteristics, which can suppress the fluctuation in moving speed and displacement position of the carriage.

### BRIEF DESCRIPTION OF THE DRAWINGS

FIG. 1 is a block diagram showing a seek control section of an optical disk apparatus according to the present invention;

FIG. 2 is a schematic diagram showing a basic configuration of an actuator of an optical head including a carriage actuator and a lens actuator;

FIG. 3 is a block diagram showing a controller that controls the stepping motor;

FIGS. 4A to 4B are schematic diagrams showing a relation between a carriage motion control and an objective lens position control, in a tracking action;

FIG. 5 is a flowchart showing an excitation pattern learning process I on with respect to a one-phase excitation drive mode;

FIG. 6 is a flowchart showing an excitation pattern learning process II with respect to a two-phase excitation drive mode;

FIG. 7 is a flowchart showing an excitation pattern learning process III with respect to a one-two-phase excitation drive mode;

FIG. 8 is a line graph showing a variation in relative displacement position of an objective lens upon moving the carriage with one driving pulse;

FIGS. 9A to 9C are diagrams showing a rotation mechanism of a HB type two-phase stepping motor;

FIG. 10 is a chart showing a relation between a conduction pattern to an A-phase exciting coil and a B-phase exciting coil and a torque and rotation speed of a rotor, in the one-phase excitation drive mode;

FIG. 11 is a schematic diagram showing a relation between a direction of the exciting current and a rotational position of the rotor, in the one-phase excitation drive mode;

FIG. 12 is a chart showing a relation between a conduction pattern to an A-phase exciting coil and a B-phase exciting coil and a torque and rotation speed of a rotor, in the two-phase excitation drive mode;

FIG. 13 is a schematic diagram showing a relation between a direction of the exciting current and a rotational position of the rotor, in the two-phase excitation drive mode;

FIG. 14 is a line graph showing a shift in rotational positions in each excitation mode caused by imbalance in torque, in the two-phase excitation drive mode;

FIG. 15 is a chart showing a relation between a conduction pattern to an A-phase exciting coil and a B-phase exciting coil and a torque and rotation speed of a rotor, in the one-two-phase excitation drive mode; and

FIG. 16 is a schematic diagram showing a relation between a direction of the exciting current and a rotational position of the rotor, in the one-two-phase excitation drive mode.

### DETAILED DESCRIPTION OF THE PREFERRED EMBODIMENT

A preferred embodiment of the present invention will be described below with reference to the accompanying drawings.

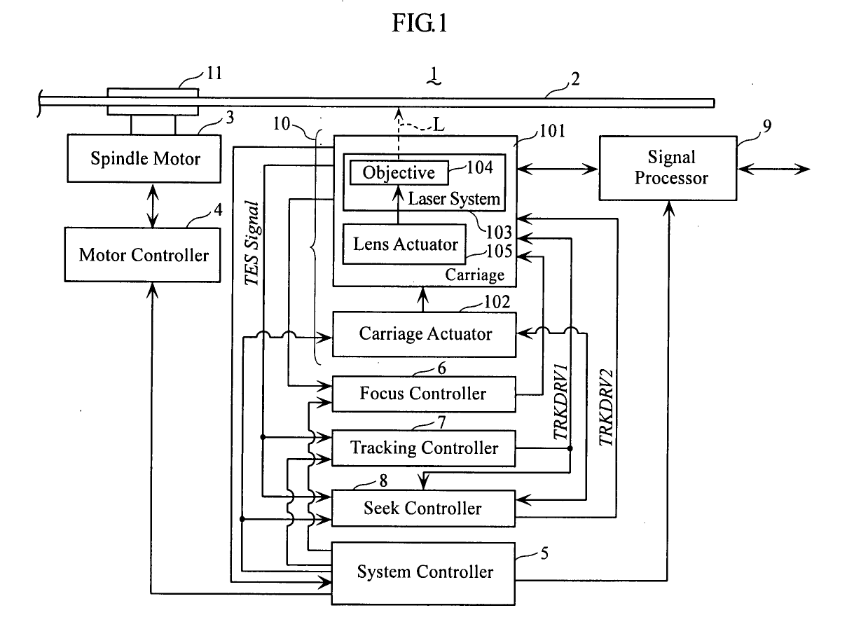

FIG. 1 is a block diagram showing a seek control section of an optical disk apparatus according to the present invention.

The optical disk apparatus 1 includes, as constituents associated with seek control, a spindle motor 3 that rotates an optical disk 2, a spindle motor controller 4 that controls the rotation of the spindle motor 3, an optical head 10 that generates a beam spot L from a laser beam to illuminate the optical disk 2 for reading and writing data, a carriage actuator 102 that moves a carriage 101, which is a component of the optical head 10, radially of the optical disk 2, a focus controller 6 that controls the focus of the beam spot L emitted by the optical head 10 onto the optical disk 2, a tracking controller 7 that controls an incident position of the beam spot L emitted by the optical head 10 onto the optical disk 2 so as to move the beam spot L along a track of the optical disk 2 during the rotation thereof, a seek controller 8 that controls the radial movement of the beam spot L with respect to the optical disk 2 so as to set the beam spot L at a designated track of the optical disk 2 to record or reproduce the data, a signal processor 9 that performs a predetermined processing with respect to a signal input to and output from the optical head 10 when recording or reproducing data in or out of the optical disk 2, and a system controller 5 that controls the action of the spindle motor controller 4 and each of the focus controller 6 to the signal processor 9.

The spindle motor controller 4 and each of the system controller 5 to the focus controller 9 are primarily constituted of a software, so that a MPU provided for the respective controllers executes the program so as to achieve actual actions.

The spindle motor 3 is a brushless DC motor for example, and installed on a supporting member for the central hole of the optical disk 2. Rotating the spindle motor 3 at a predetermined speed and in a predetermined direction (clockwise when viewed from above the optical disk 2) causes the optical disk 2 to rotate at a predetermined constant speed. The drive control of the spindle motor 3 is executed based on a control signal from the spindle motor controller 4. In the case of a three-phase brushless DC motor for example, the spindle motor controller 4 provides a square wave signal for 120 degrees conduction to the spindle motor 3.

The drive control of the spindle motor 3 is executed by the system controller 5. The system controller 5 outputs a timing signal instructing to start or stop the spindle motor 3 to the spindle motor controller 4, so that the spindle motor controller 4 controls the starting and stopping action of the spindle motor 3 based on the timing signal.

The optical head 10 includes the carriage 101 and the carriage actuator 102 that moves the carriage 101 radially of the optical disk 2. The carriage 101 accommodates a laser optical system 103 that generates a laser beam with a semiconductor laser and converges the laser beam through an objective lens 104 into a fine beam spot L thus to emit the beam spot onto the surface of the optical disk 2, and a lens actuator 105 that displaces the objective lens 104 radially of the optical disk 2.

The laser optical system 103 serves to lead the laser beam generated by a laser source (not shown) to the objective lens 104 so as to irradiate the optical disk 2 with the beam spot L, and to lead the beam reflected by the optical disk 2 and incident back upon the objective lens 104 to the signal processor 9, and the system also includes an optical system that detects a focus control signal for adjusting the focus of the beam spot L emitted onto the optical disk 2 through the objective lens 104, and an optical system that detects a tracking control signal for the beam spot L.

The objective lens 104 serves to converge the laser beam led by the laser optical system, to thereby form a beam spot L of a predetermined diameter (for example, 1.6 μm approximately) on the surface of the optical disk 2.

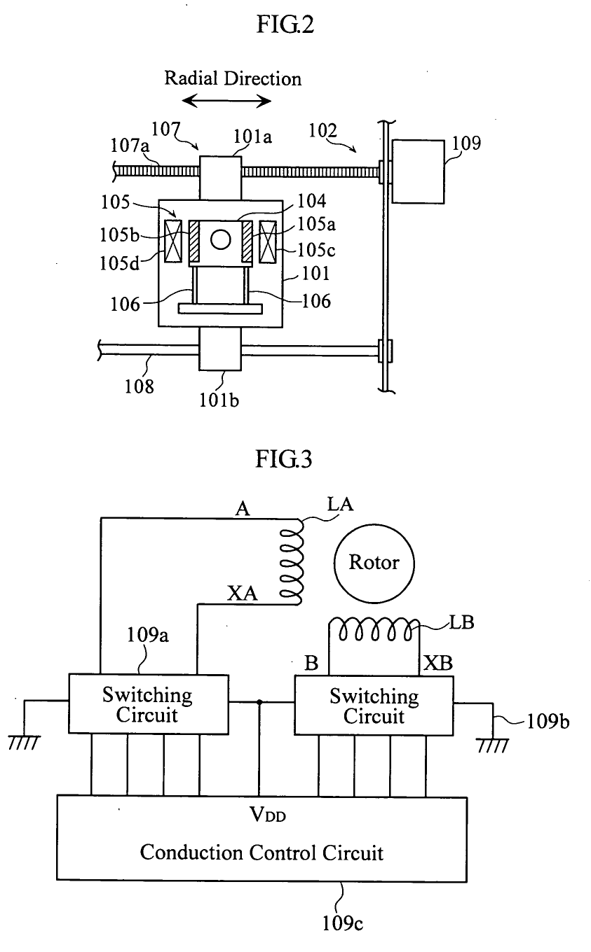

FIG. 2 is a schematic diagram showing a basic configuration of the actuator of the optical head including the carriage actuator and the lens actuator.

The optical head 10 includes the carriage 101, the carriage actuator 102 that moves the carriage 101 radially of the disk, the objective lens 104 supported on the carriage 101 by four springs 106, and the lens actuator 105 that moves independently the objective lens 104 radially of the disk. Here, description on a focus detection system and a tracking signal detection system mounted on the carriage 101 is omitted.

The carriage actuator 102 includes a motor 109 serving as the source of driving force for the carriage 101, and a transmission mechanism 107 that converts the rotational force of the motor 109 into a linear force for transmission to the carriage 101. A two-phase stepping motor may be employed as the motor 109, because of excellent positioning control performance and compatibility with a digital control system.

FIG. 3 is a block diagram showing the controller that controls the stepping motor.

The stepping motor 109 is a claw-pole PM (permanent magnet) motor with two exciting coils LA, LB for A-phase and B-phase respectively, for example. The stepping motor 109 is connected to a controller including two switching circuits 109a, 109b and a conduction control circuit 109c that control the current conduction to the exciting coils LA, LB, so that the controller executes the rotation control of the stepping motor 109.

The switching circuit 109a includes switching devices including four transistors bridge-connected to the A-phase exciting coil LA, such that one end of the bridge circuit including the A-phase exciting coil LA and the four switching devices is grounded, and the other end receives a driving voltage VDD from the conduction control circuit 109c. The switching circuit 109b is of a similar configuration to that of the switching circuit 109a.

Controlling ON/OFF of the four switching devices in the switching circuit 109a allows conduction through the exciting coil LA, from A side to XA side (A-phase forward excitation) and from XA side to A side (A-phase reverse excitation). Likewise, controlling ON/OFF of the four switching devices in the switching circuit 109b allows conduction through the exciting coil LB, from B side to XB side (B-phase forward excitation) and from XB side to B side (B-phase reverse excitation).

The switching action of the switching circuits 109a, 109b is controlled by the conduction control circuit 109c. The conduction control circuit 109c controls the current conduction to the exciting coil LA, LB via the switching circuits 109a, 109c, i.e. the combinations of “A-phase forward conduction”, “A-phase reverse conduction”, “B-phase forward conduction” and “B-phase reverse conduction”, so as to drive the stepping motor 109 in one of the one-phase excitation drive, the two-phase excitation drive and the one-two-phase excitation drive. In addition, the conduction control circuit 109c can also drive the stepping motor 109 in a microstep mode.

The conduction control circuit 109c also generates a control signal in a form of a pulse signal to input the switching circuits 109a, 109b, thereby performing a chopper control of the driving voltage VDD applied to the exciting coils LA, LB, thus controlling the exciting current to be supplied to the exciting coils LA, LB. The drive control of the conduction control circuit 109c, hence the drive control of the stepping motor 109 is executed by the seek controller 8.

Referring back to FIG. 2, the transmission mechanism 107 is connected to the rotor of the stepping motor 109, and includes a male-threaded shaft 107a and a first supporting portion 101a projecting from a side face (upper face in FIG. 2) of the carriage 101 and including a female thread formed at a distal portion so as to thread-fit with the shaft 107a. The carriage 101 is also provided with a second supporting portion 101b including a through hole formed at a distal portion and projecting from the other side face (lower face in FIG. 2), and a guide bar 108 is disposed parallel to the shaft 107a so as to penetrate the through hole of the second supporting portion 101b. The shaft 107a and the guide bar 108 are oriented parallel to a radial direction of the optical disk 2.

Accordingly, when the stepping motor 109 is rotated, the rotational force is converted into a linear force by the transmission mechanism 107 and transmitted to the first supporting portion 101a, so that the carriage 101 slides along the guide bar 108 i.e. radially of the disk, which causes the beam spot L to move radially of the optical disk 2 in a larger travel distance (rough seek action).

Since the stepping motor 109 rotates in the increment of the step angle θs, the carriage 101 moves in a travel distance unit determined by converting the step angle θs into a radial travel distance Xr (hereinafter, “unit travel distance”). In this embodiment, the shaft 107a is threaded in a pitch of 1 mm and the step angle θs of the stepping motor 109 is 18 degrees. Accordingly, the unit travel distance Xr of the carriage 101 per driving pulse is obtained as:
Xr=1000 [μm]×18 [degrees]/360 [degrees]=50 [μm].

The unit travel distance Xr is the distance traveled by the carriage 101 per driving pulse (mm/pulse). Accordingly, detecting the pulse signals (driving pulses) per second that drives the stepping motor 109 leads to detection of the moving speed K (mm/second) of the carriage 101.

Upon setting a target value N (pulse/second (pps)) with respect to the rotation control of the stepping motor 109, the moving speed K (mm/second) of the carriage 101 can be obtained by Xr×N. Here, the seek action of the carriage 101 is controlled by the seek controller 8, which outputs the target value N for the rotation control of the stepping motor 109, to the carriage actuator 102. Therefore, the moving speed K of the carriage 101 during the seek action is calculated by the seek controller 8.

The lens actuator 105 includes a pair of magnets 105a, 105b respectively located on both sides of the housing of the objective lens 104, and a pair of electromagnets 105c, 105d disposed so as to oppose the magnets 105a, 105b. The magnets 105a, 105b and the electromagnets 105c, 105d are aligned parallel to an axial direction of the guide bar 108 (i.e. parallel to a radial direction of the optical disk 2).

When a current is not supplied to the coil of the electromagnets 105c, 105d, the objective lens 104 remains at a neutral point M (hereinafter, “reference position M”) supported by the springs 106, but is displaced from the reference position M by an attractive force of the electromagnet 105c or the electromagnet 105d when a current is supplied to the coil thereof. The amount of such displacement is determined by the current amount supplied to the electromagnet 105c or the electromagnet 105d, within a range ±dmax of, for example, ±30 [μm].

Accordingly, controlling the direction and amount of the current conduction to the electromagnet 105c or the electromagnet 105d allows moving the objective lens 104 on the carriage 101 independently from the motion thereof radially of the optical disk 2, and thereby moving the beam spot L radially of the optical disk 2, in a minute travel distance (precise seek action).

Since the displacement amount of the objective lens 104 from the reference position M on the carriage 101 is proportionate to the current conduction amount to the pair of electromagnets 105c, 105d, the displacement amount of the objective lens 104 from the reference position M on the carriage 101 is grasped based on the current conduction amount, in this embodiment.

Alternatively, a position detector may be provided close to the objective lens 104 on the carriage 101, so as to detect the displacement amount of the objective lens 104 with respect to the reference position M.

As a specific example, the carriage 101 may be provided with a position detector constituted of a reflective optical sensor including a light emitter and a photodetector and a signal processor that processes the detection signal of the reflective optical sensor, so that in the position detector the photodetector receives the light emitted by the light emitter toward the objective lens 104 and thereby reflected, and the signal processor calculates the displacement amount of the objective lens 104 from the reference position M based on the amount of the received light. Thus, the position detector detects the displacement position of the objective lens 104 from the reference position M.

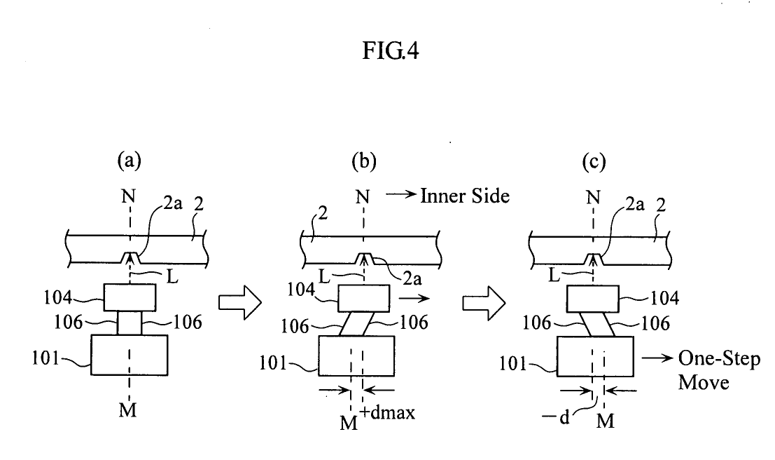

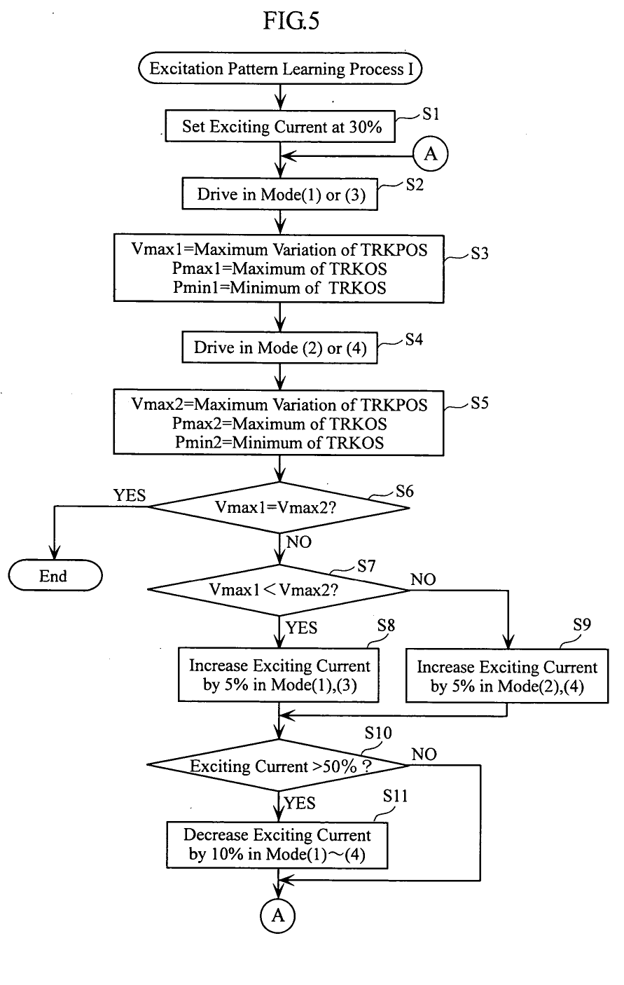

FIGS. 4A to 4C are schematic diagrams showing a relation between the motion control of carriage 101 and the displacement control of the objective lens 104, in the tracking action.

The objective lens 104 is attached to the carriage 101 so as to be able to be displaced within a range of ±dmax from the reference position M, radially of the optical disk 2. The carriage 101 is driven by a linear force in a radial direction converted from the rotational force of the stepping motor 109.

When the optical disk 2 is rotated with the beam spot L from the objective lens 104 formed properly upon the groove 2a of the optical disk 2 (FIG. 4A), so that the groove 2a moves inwardly on the optical disk 2, firstly the objective lens 104 alone is displaced inwardly of the optical disk 2 so that the beam spot L can follow up the groove 2a. Then, when the objective lens 104 is displaced on the carriage 101 to the maximum amount +dmax (FIG. 4B), the carriage 101 is moved inwardly of the optical disk 2 by a unit travel distance Xr corresponding to the step angle θs, and also the objective lens 104 is relatively displaced outwardly of the optical disk 2 with respect to the carriage 101, so that the beam spot L can follow up the movement of the groove 2a.

Thereafter, through the combination of the movement of the carriage 101 by the unit travel distance Xr and the minute displacement of the objective lens 104, the formed position of the beam spot L on the optical disk 2 can relatively move along the groove 2a of the optical disk 2.

Now referring back to FIG. 1, the focus controller 6 serves to automatically adjust the focal point of the beam spot L formed upon the optical disk 2 through the objective lens 104, with respect to the track of the optical disk 2. The optical disk 2 is slightly vibrating up and down during the rotation, which causes the focal point of the beam spot L formed upon the track of the optical disk 2 to be deviated. The laser optical system 103 of the optical head 10 includes a focus signal detector that detects a signal representing the deviation of the focal point of the beam spot L, based on the light reflected by the optical disk 2, so that the focus controller 6 displaces the optical system for focus control in the laser optical system 103 based on the signal output from the focus signal detector, thus automatically adjusting the focal point of the beam spot L on the track of the optical disk 2.

The tracking controller 7 serves to automatically micro-adjust the exposed position of the beam spot L on the optical disk 2, so as to cause the beam spot L to relatively move on the designated track during the rotation of the optical disk 2. Since the optical disk 2 is decentered, the track on the optical disk 2 slightly deviates, despite being concentrically formed on the optical disk 2, to the left or the right from a position where that track would be if the optical disk 2 were not eccentrically shaped. This also applies when the track is formed in a spiral.

The laser optical system 103 of the optical head 10 includes a tracking error signal detecting circuit that detects a signal representing the shift of the beam spot L from the track (TES signal) based on the light reflected by the optical disk 2, so that the tracking controller 7 causes the lens actuator 105 to move the objective lens 104 on the carriage 101 based on the TES signal output from the tracking error signal detector, thus automatically adjusting the incident position of the beam spot L on the track of the optical disk 2.

The seek controller 8 serves to control the seek action of moving the carriage 101 or the objective lens 104 radially of the optical disk 2, thus to quickly set the beam spot L correctly at the designated track position. The seek controller 8 executes the seek action control based on a control signal from the system controller 5.

The system controller 5, for example upon receipt of a data writing instruction from a computer connected to the optical disk apparatus 1, transmits data to be sent with the instruction and also transmits information in a recording region on the optical disk 2 where the above-mentioned data is to be written in (i.e. information on the track number and the sector number), to the seek controller 8. The seek controller 8 moves the carriage 101 or the objective lens 104 radially of the optical disk 2 based on the information on the recording region, so as to set the beam spot L at the data writing position (corresponding to the designated track number and the sector number).

The signal processor 9 includes a modulating circuit and a demodulating circuit, so as to modulate the data transmitted by the computer according to a predetermined modulation method when writing the data in the optical disk 2, and to input the modulated signal to the optical head 10. The optical head 10 generates a pulse signal for recording the data in the optical disk 2 based on the modulated signal, and then generates the laser beam according to the pulse signal, to thus irradiate the optical disk 2 with the pulse beam for recording the data. When reading out the data from the optical disk 2, a signal output by the optical head 10 according to the reflection of the beam spot L from the optical disk 2 is demodulated by a predetermined demodulation method, and the demodulated signal is output to a data reproducing circuit (not shown) in a posterior stage.

The system controller 5 serves to integrally control the operation of the spindle motor controller 4, and each of the focus controller 6 to the signal processor 9, to thereby write and read the data in and out of the optical disk 2 of the optical disk apparatus 1.

The system controller 5 also has a learning function for appropriately adjusting the exciting current to be supplied to the exciting coils LA, LB in the respective excitation modes so as to substantially uniformize the torque, to thereby suppress the fluctuation in rotation speed and rotational position originating from a difference in excitation characteristic between the two exciting coils LA, LB of the stepping motor 109.

Now according to flowcharts shown in FIGS. 5 to 7, description will be given on the learning process of the system controller 5 for controlling the exciting current to be supplied to the stepping motor 109 (hereinafter, “excitation pattern”) in the respective excitation modes.

The system controller 5 performs the learning while data is not being written in or read out of the optical disk 2, such as a start-up or a stand-by period of the optical disk apparatus 1, for suppressing the fluctuation in moving speed and moving position of the carriage 101 due to uneven torque generated by the stepping motor 109.

To start with, a learning process I on the excitation pattern for driving the stepping motor 109 in the one-phase excitation drive mode will be described according to the flowchart of FIG. 5.

The first step is setting the exciting current to be supplied to the A-phase exciting coil LA and the B-phase exciting coil LB in the excitation modes (1) to (4) of the one-phase excitation drive mode, at 30% (Si). In other words, the chopper control of the driving voltage VDD applied to the A-phase exciting coil LA and the B-phase exciting coil LB by the switching circuits 109a, 109b is executed by a control signal having a duty ratio of 30%.

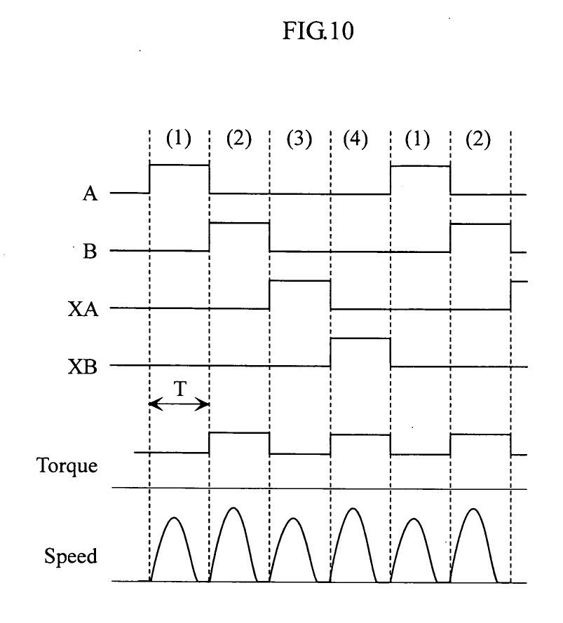

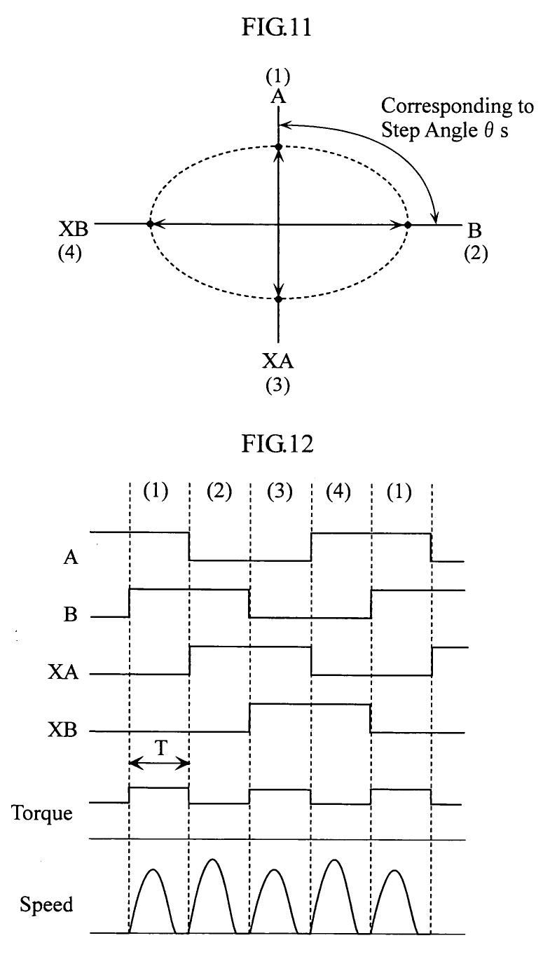

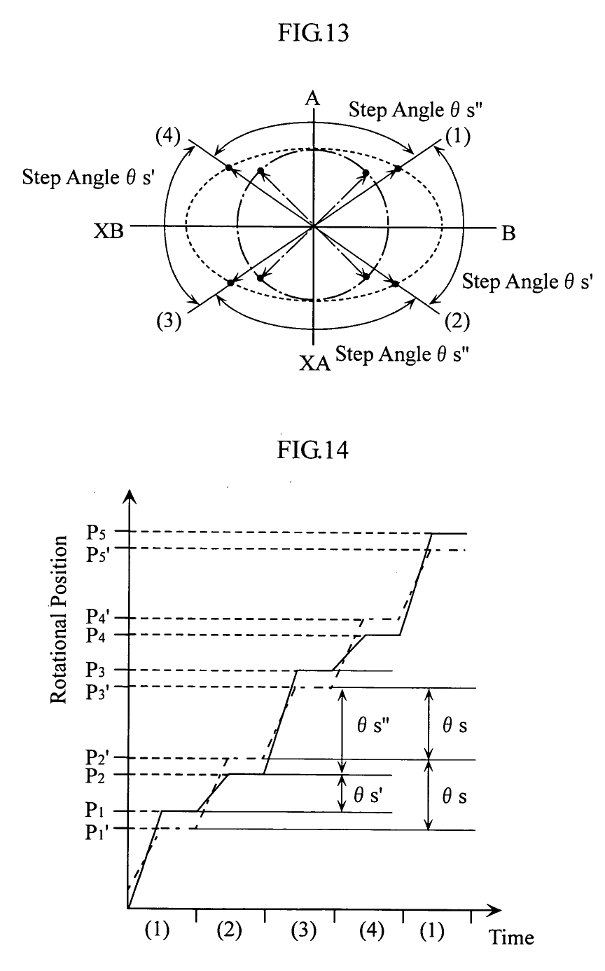

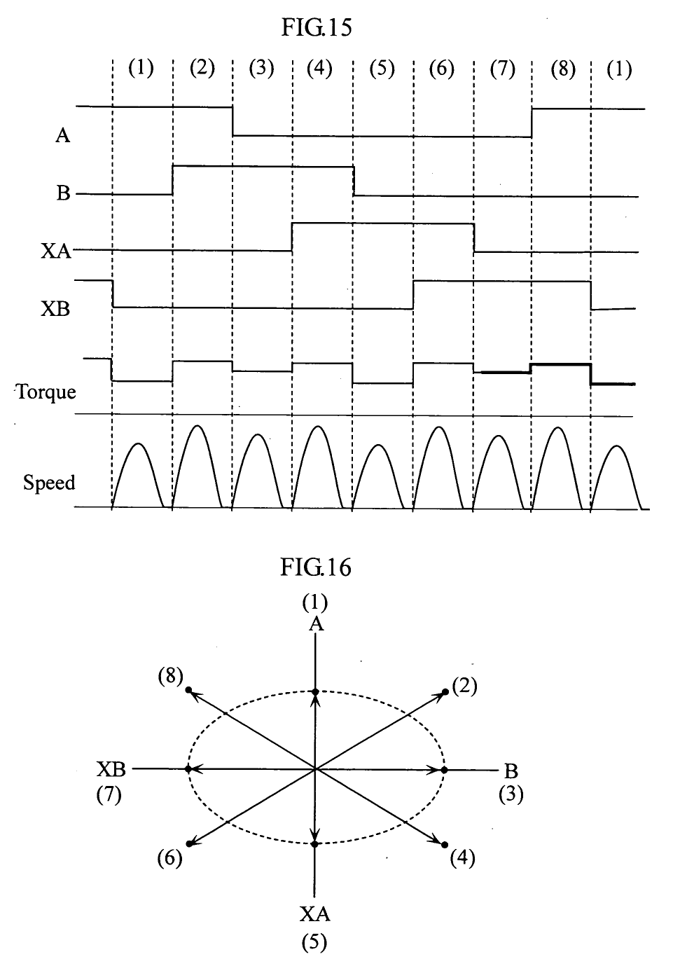

Then the exciting current is supplied only to the A-phase exciting coil LA to drive the stepping motor 109 (S2). In other words, the stepping motor 109 is driven according to the excitation mode (1) or (3) (Ref. excitation mode (1), (3) in FIG. 10). With this motion, information on a travel distance V of the carriage 101 is detected, and stored in a register (S3).

As already stated, the objective lens 104 keeps the beam spot L at the track position of the optical disk 2 by the tracking control. If the optical disk 2 does not rotate and hence the track position remains unchanged, the position of the objective lens 104 with respect to the optical disk 2 also remains unchanged. Accordingly, rotating the stepping motor 109 in the excitation mode (1) or (3) thus to move the carriage 101 by one driving pulse under such state causes the carriage 101 to relatively move with respect to the objective lens 104.

Since the relative travel distance V of the carriage 101 with respect to the objective lens 104 is equivalent to a relative displacement amount of the objective lens 104 with respect to the carriage 101, obtaining the displacement amount of the objective lens 104 with respect to the carriage 101 leads to detection of the travel distance V of the carriage 101.

Since the displacement amount of the objective lens 104 from the reference position M is proportionate to a current conduction amount to the pair of electromagnets 105c, 105d, as already mentioned, the travel distance V of the carriage 101 can be detected based on the amount of current conduction. Here, in the case where the position detector is provided, the travel distance V of the carriage 101 may be detected according to the position of the objective lens 104 detected by the position detector.

To be more detailed, the position of the objective lens 104 on the carriage 101 where the beam spot L is set on the tracking position is regarded as the initial position, and the stepping motor 109 is driven by one driving pulse in the excitation mode (1) thus to move the carriage 101. Then a change in current conduction amount to the pair of electromagnets 105c, 105d for relatively displacing the objective lens 104 with respect to the carriage 101 is measured, so that the displacement amount of the objective lens 104 on the carriage 101 is detected based on the measurement result.

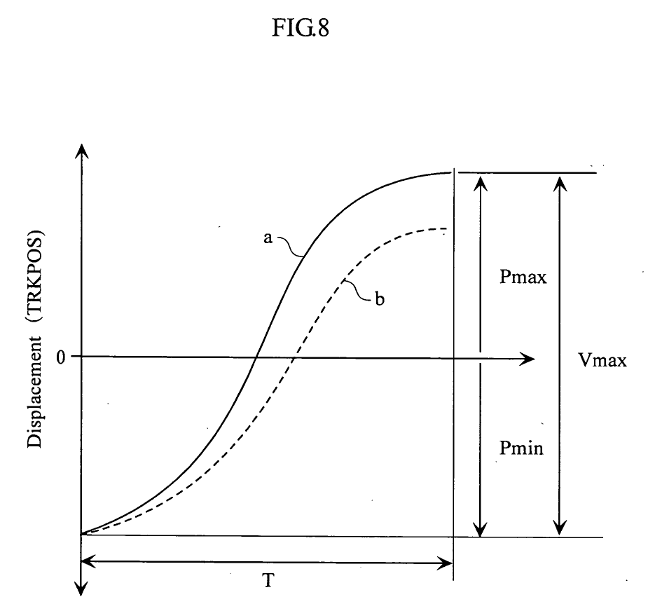

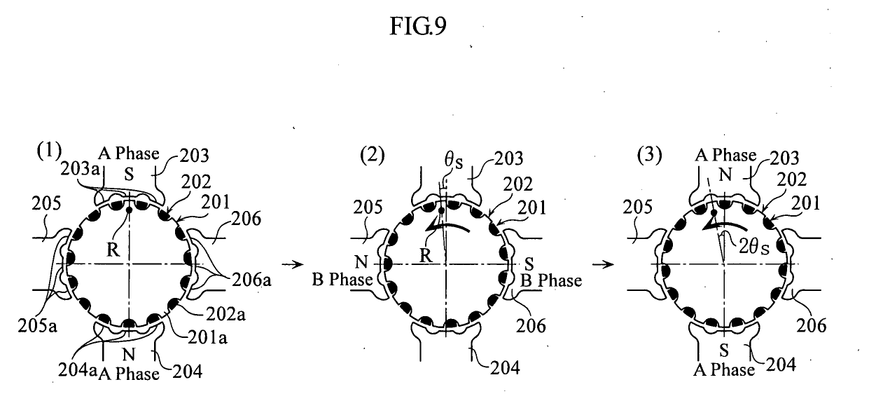

FIG. 8 is a graph showing a variation in the relative displacement position of the objective lens upon moving the carriage with one driving pulse.

In FIG. 8, the period T along the horizontal axis represents the period of the excitation mode (1) or (3), which corresponds to the cycle of the driving pulse provided to the stepping motor 109 (for example, 5 to 6 ms). The vertical axis represents the displacement position of the objective lens 104 from the reference position M, on which “0” corresponds to the reference position M, a displacement in the negative side means a displacement to an inner region of the optical disk 2, while a displacement in the positive side means a displacement to an outer region thereof.

FIG. 8 indicates a variation in relative displacement position TRKPOS of the objective lens 104 at the time that the stepping motor 109 is driven with one driving pulse in the excitation mode (1) thus to move the carriage 101, under an initial state that the objective lens 104 is displaced to the maximum distance −dmax (−30 μm in this embodiment) from the reference position M. In the figure, a reason that the objective lens 104 is displaced over both of the positive and negative side of the reference position M is that, since the travel distance of the carriage 101 corresponding to a rotation of the stepping motor 109 by one driving pulse in the excitation mode (1) is 50 μm approximately, the movement of the carriage 101 causes the objective lens 104 to be relatively displaced by 50 μm outwardly of the optical disk 2 on the carriage 101, and the position after the displacement falls on +20 μm from the reference position M, which is opposite to the initial position.

It is to be noted that the waveform A shown by a solid line represents the displacement under a great torque, while the waveform B shown by a broken line the displacement under a small torque. Such difference is created because the travel distance of the carriage 101 becomes greater with the increase in torque, resulting in an increase in relative displacement amount of the objective lens 104 with respect to the carriage 101.

When the stepping motor 109 is driven by one driving pulse in the excitation mode (3), a state that the objective lens 104 is displaced on the carriage 101 to the maximum distance +dmax (+30 μm in this embodiment) from the reference position M is regarded as the initial state. Accordingly, the waveform representing the displacement position of the objective lens 104 becomes an inversion of the waveform shown in FIG. 8.

In this embodiment, upon defining a minimum value of the displacement position TRKPOS of the objective lens 104 (maximum value of the displacement position TRKPOS on the negative side of the reference position M) as Pmin1, a maximum value of the displacement position TRKPOS of the objective lens 104 (maximum value of the displacement position TRKPOS on the positive side of the reference position M) as Pmax1, and a maximum value of variation in displacement position TRKPOS of the objective lens 104 (corresponding to |Pmax1-Pmin1|) as Vmax1 (Ref. FIG. 8), the minimum value Pmin1, the maximum value Pmax1 of the displacement position TRKPOS of the objective lens 104, and the maximum value Vmax1 representing the variation in displacement position TRKPOS are detected through the process of the step S3, and the detected values are stored in the register as the information on the travel distance V of the carriage 101.

Then the exciting current is supplied only to the B-phase exciting coil LB to drive the stepping motor 109 (S4). In other words, the stepping motor 109 is driven according to the excitation mode (2) or (4) (Ref. excitation mode (2), (4) in FIG. 10). Then, similarly to the step S3, the information of the travel distance V of the carriage 101 achieved by this drive (the minimum value Pmin2 and the maximum value Pmax2 of the displacement position TRKPOS of the objective lens 104, as well as the maximum value Vmax2 representing the variation in displacement position TRKPOS) is detected and stored in the register (S5).

The above is followed by comparison of the variation amount of the displacement position TRKPOS, between the maximum value Vmax1 and the maximum value Vmax2 (S6, S7). If Vmax1 is smaller than Vmax2 (S6: NO, S7: YES), the exciting current for the A-phase exciting coil LA is increased by 5% (S8). On the other hand, if Vmax1 is greater than Vmax2 (S6: NO, S7: NO), the exciting current for the B-phase exciting coil LB is increased by 5% (S9).

The next step is decision on whether the adjusted exciting current is greater than 50% (S10), and if the exciting current is not greater than 50% (S10: NO), the process returns to the step S2 so as to resume the drive of the stepping motor 109 in the excitation mode (1) or (3) as well as in the excitation mode (2) or (4), to thereby detect the information on the travel distance V of the carriage 101 in the both excitation modes (S2 to S5).

On the other hand, if the adjusted exciting current is greater than 50% (S10: YES), the adjusted exciting current is decreased by 10% (S11) and then the process returns to the step S2 so as to resume the drive of the stepping motor 109 in the excitation mode (1) or (3) as well as in the excitation mode (2) or (4), to thereby detect the information on the travel distance V of the carriage 101 in the both excitation modes (S2 to S5).

If Vmax1 is equal to Vmax2 (S6: YES), the exciting current for the A-phase exciting coil LA and the B-phase exciting coil LB at that moment is set as the exciting current for writing/reading data in and out of the optical disk 2, thus completing the learning process I on the excitation pattern. For example, if Vmax1 becomes equal to Vmax2 when the exciting current for the A-phase exciting coil LA is increased to 35% while the exciting current for the B-phase exciting coil LB remains 30%, such exciting currents are set as the exciting current for writing/reading data in and out of the optical disk 2.

Thus, the exciting current for the A-phase exciting coil LA and that for the B-phase exciting coil LB are adjusted within a range 50% of the exciting current, such that the maximum values Vmax1 and Vmax2 of the variation in displacement position TRKPOS of the objective lens 104 in each excitation mode of the one-phase excitation drive mode, i.e. the torque values in each excitation mode, become substantially equivalent.

Here, a reason that the exciting current is adjusted within a range of 50% is that, as already stated, the fluctuation in moving speed and displacement position of the carriage 101 caused by a difference in torque between the excitation modes (1), (3) and the excitation modes (2), (4) becomes particularly prominent when the torque is in a relatively lower range. Another reason is that, in the case of a motor that generates a fluctuating torque but in a relatively higher torque range as a whole, the learning result becomes a greater value than a minimum necessary torque for rotating the rotor, which may turn the advantageous effect of the present invention invisible.

Accordingly, in this embodiment the exciting current is adjusted such that the torque in the excitation modes (1), (3) and the torque in the excitation modes (2), (4) become substantially the same in a range close to the minimum torque.

Here, in the decision made at the steps S6, S7 of FIG. 5, the comparison may be made between |Pmax1-Pmin1| and |Pmax2-Pmin2|, instead of the maximum values Vmax1 and Vmax2 of the variation amount.

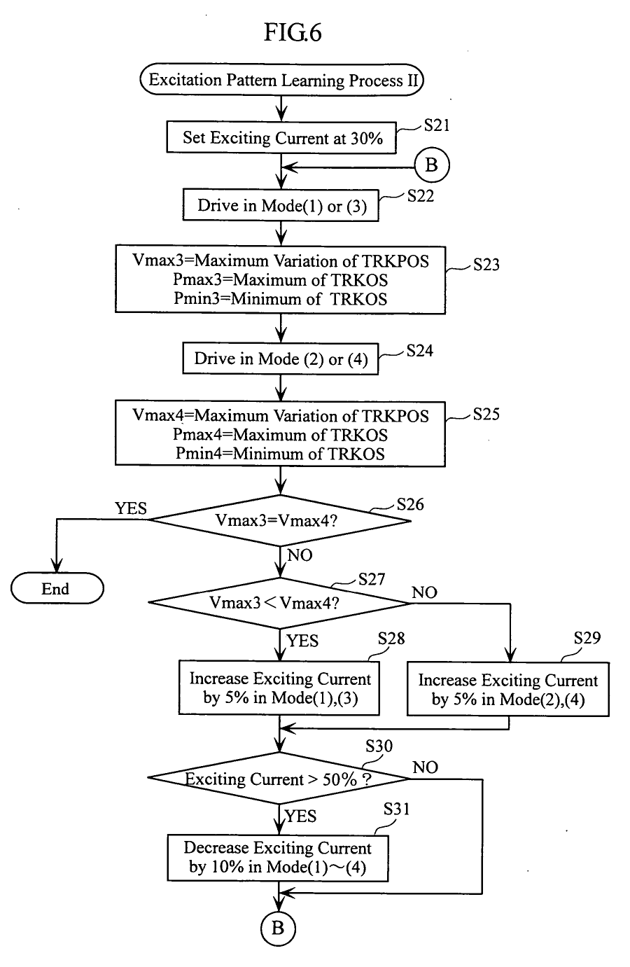

Now, a learning process II on the excitation pattern for driving the stepping motor 109 in the two-phase excitation drive mode will be described according to the flowchart of FIG. 6.

The learning process II on the excitation pattern in the two-phase excitation drive mode is basically the same as the learning process I on the excitation pattern in the one-phase excitation drive mode. The process of the steps S21 to S31 of FIG. 6 corresponds to that of the steps S1 to S11 of FIG. 5.

Firstly, the exciting current to be supplied to the A-phase exciting coil LA and the B-phase exciting coil LB in the excitation modes (1) to (4) of the two-phase excitation drive mode is set at 30% (S21).

Then the stepping motor 109 is driven according to the excitation mode (1) or (3) (Ref. excitation mode (1), (3) in FIG. 12) of the two-phase excitation drive mode. With this motion, information on a travel distance V of the carriage 101 is detected, and stored in a register (S23). Specifically, the minimum value Pmin3, the maximum value Pmax3 of the displacement position TRKPOS of the objective lens 104, and the maximum value Vmax3 representing the variation in displacement position TRKPOS are detected, and such detected values are stored in the register as information on the travel distance V of the carriage 101.

Here, the minimum value Pmin3 and the maximum value Pmax3 of the displacement position TRKPOS of the objective lens 104, and the maximum value Vmax3 representing the variation in displacement position TRKPOS respectively correspond to the minimum value Pmin, maximum value Pmax of the displacement position TRKPOS of the objective lens 104, and the maximum value Vmax representing the variation in displacement position TRKPOS shown in FIG. 8.

Then the stepping motor 109 is driven according to the excitation mode (2) or (4) of the two-phase excitation drive mode (Ref. excitation mode (2), (4) in FIG. 12). As performed at the step S23, the information of the travel distance V of the carriage 101 achieved by this drive (the minimum value Pmin4 and the maximum value Pmax4 of the displacement position TRKPOS of the objective lens 104, as well as the maximum value Vmax4 representing the variation in displacement position TRKPOS) is detected and stored in the register (S25).

The above is followed by comparison of the variation amount of the displacement position TRKPOS, between the maximum value Vmax3 and the maximum value Vmax4 (S26, S27). If Vmax3 is smaller than Vmax4 (S26: NO, S27: YES), the exciting current for the A-phase exciting coil LA and the B-phase exciting coil LB in the excitation modes (1), (3) is increased by 5% (S28). On the other hand, if Vmax3 is greater than Vmax4 (S26: NO, S27: NO), the exciting current for the A-phase exciting coil LA and the B-phase exciting coil LB in the excitation modes (2), (4) is increased by 5% (S29).

The next step is decision on whether the adjusted exciting current is greater than 50% (S30), and if the exciting current is not greater than 50% (S30: NO), the process returns to the step S22 so as to resume the drive of the stepping motor 109 in the excitation mode (1) or (3) as well as in the excitation mode (2) or (4) of the two-phase excitation drive mode, to thereby detect the information on the travel distance V of the carriage 101 in the both excitation modes (S22 to S25).

On the other hand, if the adjusted exciting current is greater than 50% (S30: YES), the adjusted exciting current is decreased by 10% (S31) and then the process returns to the step S22 so as to resume the drive of the stepping motor 109 in the excitation mode (1) or (3) as well as in the excitation mode (2) or (4) of the two-phase excitation drive mode, to thereby detect the information on the travel distance V of the carriage 101 in the both excitation modes (S22 to S25).

If Vmax3 is equal to Vmax4 (S26: YES), the exciting current for the A-phase exciting coil LA and the B-phase exciting coil LB at that moment is set as the exciting current for writing/reading data in and out of the optical disk 2, thus completing the learning process II on the excitation pattern.

Thus, the exciting current for the A-phase exciting coil LA and that for the B-phase exciting coil LB are adjusted within a range 50% of the exciting current, such that the maximum values Vmax3 and Vmax4 of the variation in displacement position TRKPOS of the objective lens 104 in each excitation mode of the one-phase excitation drive mode, i.e. the torque values in each excitation mode, become substantially equivalent.

Here, in the decision made at the steps S26, S27 of FIG. 6, the comparison may be made between |Pmax3-Pmin3| and |Pmax4-Pmin4|, instead of the maximum values Vmax3 and Vmax4 of the variation amount.

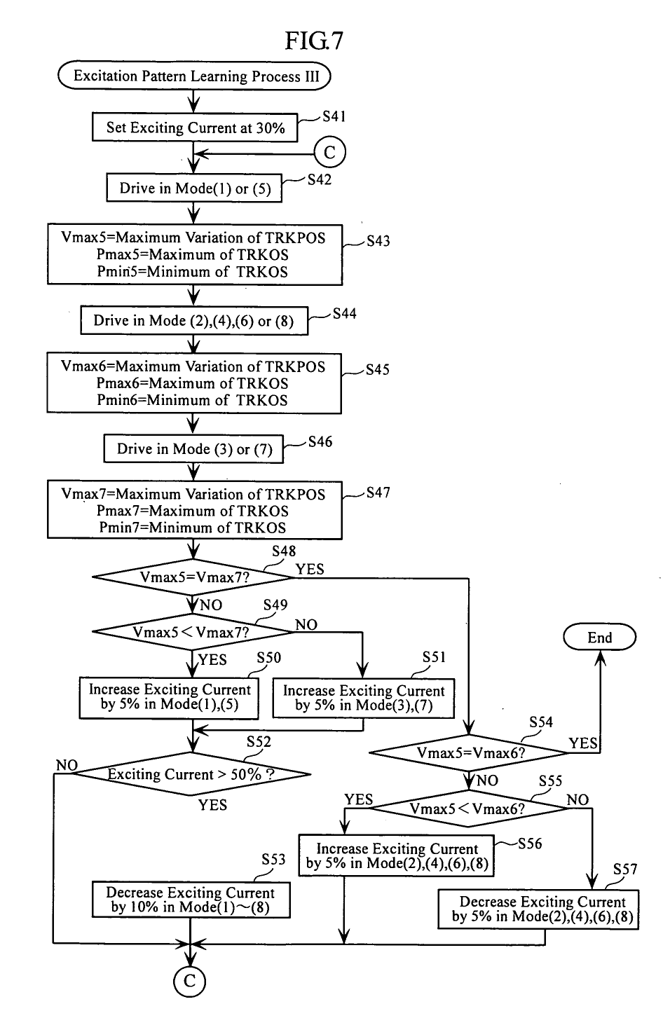

The learning process III on the excitation pattern for driving the stepping motor 109 in the one-two-phase excitation drive mode will be described according to the flowchart of FIG. 7.

Firstly, the exciting current to be supplied to the A-phase exciting coil LA and the B-phase exciting coil LB in the excitation modes (1) to (4) of the one-two-phase excitation drive mode is set at 30% (S41).

Then the exciting current is supplied only to the A-phase exciting coil LA to drive the stepping motor 109 (S42). In other words, the stepping motor 109 is driven according to the excitation mode (1) or (5) of the one-two-phase excitation drive mode (Ref. excitation mode (1), (5) in FIG. 15). With this motion, information on a travel distance V of the carriage 101 is detected, and stored in a register (S43). Specifically, the minimum value Pmin5 and the maximum value Pmax5 of the displacement position TRKPOS of the objective lens 104, and the maximum value Vmax5 representing the variation in displacement position TRKPOS are detected, and such detected values are stored in the register as information on the travel distance V of the carriage 101.

Here, the minimum value Pmin5 and the maximum value Pmax5 of the displacement position TRKPOS of the objective lens 104, and the maximum value Vmax5 representing the variation in displacement position TRKPOS respectively correspond to the minimum value Pmin, maximum value Pmax of the displacement position TRKPOS of the objective lens 104, and the maximum value Vmax representing the variation in displacement position TRKPOS shown in FIG. 8.

Then the exciting current is supplied to the A-phase exciting coil LA and the B-phase exciting coil LB thus to drive the stepping motor 109 (S44). In other words, the stepping motor 109 is driven according to the excitation modes (2), (4), (6), (8) of the one-two-phase excitation drive mode (Ref. excitation modes (2), (4), (6), (8) in FIG. 15). Then, similarly to the step S43, the information of the travel distance V of the carriage 101 achieved by this drive (the minimum value Pmin6 and the maximum value Pmax6 of the displacement position TRKPOS of the objective lens 104, as well as the maximum value Vmax6 representing the variation in displacement position TRKPOS) is detected and stored in the register (S45).

Thereafter, the exciting current is supplied only to the B-phase exciting coil LB to drive the stepping motor 109 (S46). This is according to the excitation mode (3) or (7) (Ref. excitation mode (3), (7) in FIG. 15). With this motion, information on a travel distance V of the carriage 101 is detected, and stored in a register (S47). Specifically, the minimum value Pmin7 and the maximum value Pmax7 of the displacement position TRKPOS of the objective lens 104, and the maximum value Vmax7 representing the variation in displacement position TRKPOS are detected, and such detected values are stored in the register as information on the travel distance V of the carriage 101.

The above is followed by comparison of the variation amount of the displacement position TRKPOS, between the maximum value Vmax5 and the maximum value Vmax7 (S48, S49). If Vmax5 is smaller than Vmax7 (S48: NO, S49: YES), the exciting current for the A-phase exciting coil LA in the excitation modes (1), (5) is increased by 5% (S50). On the other hand, if Vmax5 is greater than Vmax7 (S48: NO, S49: NO), the exciting current for the B-phase exciting coil LB in the excitation modes (3), (7) is increased by 5% (S51).

The next step is decision on whether the adjusted exciting current is greater than 50% (S52), and if the exciting current is not greater than 50% (S52: NO), the process returns to the step S42 so as to resume the drive of the stepping motor 109 in the excitation mode (1) or (5), in the excitation mode (2), (4), (6) or (8), and in the excitation mode (3) or (7) of the one-two-phase excitation drive mode, to thereby detect the information on the travel distance V of the carriage 101 in the respective excitation modes (S42 to S47).

On the other hand, if the adjusted exciting current is greater than 50% (S52: YES), the exciting current in the excitation modes (1) to (8) is decreased by 10% (S53), and then the process returns to the step S42 so as to resume the drive of the stepping motor 109 in the excitation mode (1) or (5), in the excitation mode (2), (4), (6) or (8), and in the excitation mode (3) or (7) of the one-two-phase excitation drive mode, to thereby detect the information on the travel distance V of the carriage 101 in the respective excitation modes (S42 to S47).

Then the steps S42 to S53 are repeated, and if Vmax5 becomes equal to max7 (S48: YES), further the maximum value Vmax5 and the maximum value Vmax6 representing the variation in displacement position TRKPOS are compared (S54, S55). If Vmax5 is smaller than Vmax6 (S54: NO, S55: YES), the exciting current for the A-phase exciting coil LA and the B-phase exciting coil LB in the excitation modes (2), (4), (6), (8) is decreased by 5% (S57), and the process returns to the step S42. On the other hand, if Vmax5 is greater than Vmax7 (S54: NO, S55: NO), the exciting current for the A-phase exciting coil LA and the B-phase exciting coil LB in the excitation modes (2), (4), (6), (8) is increased by 5%, and the process returns to the step S42.

Thus the stepping motor 109 is driven again in the excitation mode (1) or (5), in the excitation mode (2), (4), (6) or (8), and in the excitation mode (3) or (7) of the one-two-phase excitation drive mode, to thereby detect the information on the travel distance V of the carriage 101 in the respective excitation modes (S42 to S47).

The above is followed by a repetition of the steps S42 to S48 and S54 to S57, and if Vmax3 becomes equal to Vmax4 (S54: YES), the exciting current for the A-phase exciting coil LA and the B-phase exciting coil LB at that moment is set as the exciting current for writing/reading data in and out of the optical disk 2, thus completing the learning process III on the excitation pattern.

Although the travel distance of the carriage 101 is utilized for absorbing the imbalance in torque among the excitation modes in the foregoing embodiment, the moving speed of the carriage 101 may be employed for the same purpose. In other words, since the driving time based on the driving pulse T in the respective excitation modes remains unchanged, the moving speed K may be obtained from the driving time T and the travel distance V of the carriage 101, to thereby execute the learning process I to III such that the moving speed K becomes substantially the same among the excitation modes.

Further, while one of the learning processes I to III on the excitation pattern is selected according to the excitation mode for the stepping motor 109 of the optical disk apparatus 1 in the embodiment, all the learning process I to III on the excitation pattern may be performed, assuming a case where the excitation mode is arbitrarily selected.

Further, when the stepping motor 109 is driven in a microstep mode also, a similar learning process can be applied, for suppressing the fluctuation in moving speed and displacement position of the carriage 101.

As described above, the optical disk apparatus 1 according to this embodiment executes the learning process on the excitation pattern for minimizing an imbalance, if any, in generated torque between the A-phase exciting coil LA and the B-phase exciting coil LB of the stepping motor 109, thereby effectively suppressing the fluctuation in moving speed and displacement position of the carriage 101 when performing the seek action.

Such arrangement also eliminates the need to set the exciting current at a higher value to prevent the motor from running out of synchronization because of the imbalance in torque as conventionally done, thereby also contributing in reduction of power consumption, as well as of heat and vibration generated by the stepping motor 109.

Although the learning process I to III on the excitation pattern is performed in the start-up or stand-by period of the optical disk apparatus 1 in the foregoing embodiment, the learning process I to III on the excitation pattern may be executed when shipping the product, so as to store the obtained control values of the driving current for the stepping motor 109 in the memory. In addition, in the event that the stepping motor 109 runs out of synchronization thus incurring an operational error, the learning process I to III may be performed for rectifying the error.

Although the foregoing embodiment refers to the operation with a two-phase stepping motor, it is evident that the present invention is applicable to an n-phase stepping motor, without limitation to the two-phase stepping motor.

1. An optical disk apparatus provided with an optical head including a carriage disposed so as to oppose an optical disk and to move radially of the optical disk, a driver including a multi-phase stepping motor as a driving source that drives the carriage, an objective lens mounted on the carriage so as to be displaced radially of the optical disk for condensing a laser beam on the optical disk, and a shifter that displaces the objective lens, the optical disk apparatus further comprising:
a drive controller that drives the multi-phase stepping motor according to at least two conduction modes different from each other with respect to a first, a second, . . . , and an nth exciting coils of the multi-phase stepping motor;
a detector that detects a moving speed or a travel distance of the carriage in each of the conduction modes when the drive controller causes the multi-phase stepping motor to move the carriage; and
a conduction adjuster that adjusts a current amount to be supplied to the first, the second, . . . , and the nth exciting coils, according to a detection result by the detector, such that the moving speed or the travel distance of the carriage in the at least two conduction modes becomes substantially the same.

2. The optical disk apparatus according to claim 1, wherein the multi-phase stepping motor is a two-phase stepping motor, to be driven according to the conduction modes with respect to the first exciting coil and the second exciting coil.

3. The optical disk apparatus according to claim 2, wherein the conduction modes include a first conduction mode of supplying a current only to the first exciting coil and a second conduction mode of supplying a current only to the second exciting coil in a one-phase excitation drive; and the conduction adjuster adjusts a current amount to be supplied to the first exciting coil and the second exciting coil, such that the moving speed or the travel distance of the carriage in the first and the second conduction modes becomes substantially the same.

4. The optical disk apparatus according to claim 2, wherein the conduction modes include a third conduction mode of supplying a current to both the first and the second exciting coil in the two-phase excitation drive, and a fourth conduction mode of supplying a current in a different direction from that in the third conduction mode, with respect to one of the first and the second exciting coils; and the conduction adjuster adjusts a current amount to be supplied to the first exciting coil and the second exciting coil, such that the moving speed or the travel distance of the carriage in the third and the fourth conduction modes becomes substantially the same.

5. The optical disk apparatus according to claim 2, wherein the conduction modes include a fifth conduction mode of supplying a current only to the first exciting coil, a sixth conduction mode of supplying a current only to the second exciting coil, and a seventh conduction mode of supplying a current to both the first and the second exciting coil, in a one-two-phase excitation drive; and the conduction adjuster adjusts a current amount to be supplied to the first exciting coil and the second exciting coil, such that the moving speed or the travel distance of the carriage in the fifth to the seventh conduction modes becomes substantially the same.

6. The optical disk apparatus according to claim 1, wherein the detector includes a displacement position detector that detects a displacement position of the objective lens on the carriage in each of the conduction modes, and a calculator that calculates a travel distance of the carriage based on a displacement position of the objective lens detected by the displacement position detector.
